(19) United States
(12) Patent Application Publication
(10) Pub. No.: US 2014/0364674 A1
(43) Pub. Date: Dec. 11, 2014

(54) METHODS AND PRODUCTS FOR SOLIDIFICATION AND DISPOSAL OF FLUID MEDICAL WASTE

(71) Applicants: Robert Toby Wilson, Riverdale, UT (US); Tommy S. Cheng, Fontana, CA (US)

(72) Inventors: Robert Toby Wilson, Riverdale, UT (US); Tommy S. Cheng, Fontana, CA (US)

(21) Appl. No.: 14/300,494

(22) Filed: Jun. 10, 2014

Related U.S. Application Data
(60) Provisional application No. 61/833,202, filed on Jun. 10, 2013.

(51) Int. Cl. F23G 5/02; B09B 3/00; F23G 7/00

(52) U.S. Cl. CPC F23G 5/02; F23G 7/008; B09B 3/0008; B09B 3/0075; F23G 2209/20; F23G 2201/70
USPC 588/249.5

(57) ABSTRACT

Methods and products for cleanup of fluid medical waste. In one illustrative embodiment, a product may include coconut coir in a loose granulated grade, a compressed pellet grade, or mixture thereof allowing users to choose between grades more ideal for their application while achieving the same results of absorbing and solidifying all human waste and fluids for safe removal and disposal. In a second illustrative embodiment, a product may include coir in a proportion of from about 85% to about 99% and a suitable microbe for initiating bioremediation in an appropriate form in a proportion of from about 20% to about 1%, by weight.

### CROSS REFERENCE TO RELATED APPLICATIONS

This application claims priority to and incorporates by reference all of the subject matter included in Provisional Patent Application Ser. No. 61/833,202, which was filed Jun. 10, 2013.

### TECHNICAL FIELD

The present disclosure relates to products and methods for the cleanup of human bodily fluids and waste as well as liquid detergents, sanitizers and disinfectants that are used during the sanitizing and disinfecting process common in hospitals, ambulances and medical clinics.

### BACKGROUND

The cleanup of fluid medical waste typically requires absorption of the waste by an absorbent product that must then be disposed of. One known absorbent is a bentonite or clay-based material which is placed on a spill to absorb the fluid, allowing it to be swept up. However, disposing of the clay based material requires multiple steps. First the material and absorbed waste are incinerated in a medical incinerator to remove the medical waste. However, the clay based material is does not burn and a grit remains in the incinerator that then has to be disposed of in a second step.

Methods and products that allowed for the advantageous use of an absorbent that could be disposed of in a single step while complying with the applicable regulations would be an improvement in the art.

### SUMMARY

The present disclosure is directed to methods and products for cleanup of fluid medical waste. Fluid medical waste may include blood, urine, feces, vomit, and sputum as well as the liquid detergents, sanitizers and disinfectants like sodium hypochlorite (bleach), sodium hydroxide, isopropyl alcohol (IPA) and over the counter EPA registered “hospital disinfectants” that are used during the sanitizing and disinfecting process common in hospitals, ambulances and medical clinics. In one illustrative embodiment, a product may include coconut coir in a loose granulated grade, a compressed pellet grade, or mixture thereof allowing users to choose between grades more ideal for their application while achieving the same results of absorbing and solidifying all human waste and fluids for safe removal and disposal. In a second illustrative embodiment, a product may include coir in a proportion of from about 85% to about 99% and a suitable microbe for initiating bioremediation in an appropriate form in a proportion of from about 20% to about 1%, by weight.

One method of using a product may include absorbing fluid medical waste with the product then disposing of the product with the absorbed fluid by incineration.

### DETAILED DESCRIPTION

The present disclosure relates to apparatus, systems and methods related to absorbent products for fluid containing medical waste. It will be appreciated by those skilled in the art that the embodiments herein described, while illustrative, are not intended to so limit the scope of the appended claims. Those skilled in the art will also understand that various combinations or modifications of the embodiments presented herein can be made without departing from the scope of this disclosure. All such alternate embodiments are within the scope of the appended claims.

The present disclosure is directed to products and methods for the cleanup and disposal of medical waste. Products and methods in accordance with the present disclosure useful for the purposes of absorbing and solidifying all hazardous human bodily fluids and waste but not limited to; blood, urine, feces, vomit, and sputum as well as the liquid detergents, sanitizers and disinfectants like sodium hypochlorite (bleach), sodium hydroxide, isopropyl alcohol (IPA) and over the counter EPA registered “hospital disinfectants” that are used during the sanitizing and disinfecting process common in hospitals, ambulances and medical clinics.

In one illustrative embodiment, the primary ingredient of an absorbent in accordance with this disclosure may be coconut coir fiber pith having a moisture content of from about 15% to about 20%. In one formulation, the coir may be present in a loose granulated form which may have a bulk density range of from about 7 lbs/cubic foot to about 12 lbs/cubic foot. In a second formulation, the coir may be present as compressed pellets formed using about a 7:1 compression ratio and to result in a pellet having a density of from about is 20 lbs/cubic foot to about 35 lbs/cubic foot and may a desired diameter in the range of from about ⅛ inch to about ½ inch with a desired length. The diameters and lengths may vary depending on specific application requirements. The coconut coir's superior and rapid absorption of fluids will turn the hazardous fluid into a solid, more manageable and transportable substance. This result is achieved through the coconut coir's porous structure providing greater surface area and surface tension. Also, because the coconut coir's particulate structure can increase up to nine times its own mass during absorption, this allows for encapsulation. Due to the materials non-leaching characteristics, this adds additional protection against cross-contamination of other sterile objects and surfaces.

In other embodiments, a bioremediating absorbent material in accordance with the present disclosure may contain coconut coir, such as Coconut Coir Fiber Pith having a moisture content of from about 15% to about 20% H₂O, as discussed above. It may also contain one or more microbes for breaking down the absorbed medical waste in a suitable form and amount for beginning bioremediation of medical waste absorbed into the coir. Suitable microbes include bacteria in a dormant state, or bacterial spores. A blend of one or more microbes may be used for additional or increased functionality.

One example of a suitable blend that may be used is the commercially available BI-CHEM® SB Concentrate from Novozymes®. This concentrate is sold as a powder intended as a dry septic and waste degrader and is a blend of Bacillus spores characterized with a bacteria count: of about 10.0×10⁹ cfu/gram. The included microbes produce Lipase, Protease, Amylase, and/or Cellulase and are capable of both aerobic and facultative anaerobic digestion. It will be appreciated that other suitable microbes may be used and are within the scope of the present invention. Use of a bioremediating form may allow for disposal of certain medical wastes as non-hazardous material, or as hazardous material having a lesser standard for disposal, thus avoiding the need for the expense of incineration. It may also result in reduced odor and lessen the chances of contamination with absorbed medical waste being stored or transported to a suitable incinerator.

Additionally, products that use both loose granulated and compressed coir may be used. Further, additional components such as disinfects, deodorants, scents, or flow enhancing agents may be added as may be desired, although it will be appreciated that coir only product may be used.

Product in accordance with this disclosure may be ideal for spot treatments and the absorption and removal of large scale human hazardous waste spills and other Potentially Infectious Materials: (1) human bodily fluids: cerebrospinal, synovial, pleural, pericardial, peritoneal, amniotic, semen, vaginal secretions; all bodily fluids, secretions, and excretion except sweat; all bodily fluids in situations when it is difficult to differentiate between bodily fluids; (2) Any unfixed tissue or organ (other than intact skin) from a human living or dead; (3) HIV-containing cell or tissue culture, organ culture, and HIV, HCV, or HBV-containing culture medium or other solutions, allowing for greater ease for the disinfecting and sanitizing process of the contaminated spill area.

For use, a cleanup product in accordance with this disclosure is placed on the spilled medical waste and the fluid portion of the waste is absorbed. This results in the fluid waste becoming encapsulated within the product from which is prevented from leaching by the coir's absorbent properties. The waste and saturated product may be cleaned up by sweeping, or as otherwise known in the art, and the site of the spill disinfected in accordance with appropriate protocols.

The waste and saturated product may then be disposed of by incineration, following known protocols for incineration of medical waste. The product incinerates with the waste and no additional disposal steps are required as with clay-based materials. Typically, due to its variable moisture content, waste incinerated at a medical waste incinerator can have a relatively low heating value. Usually, a heating value of approximately 19,700 kJ/kg (8,500 Btu/lb) is assumed for waste which consists of trash, paper, cardboard, and wood boxes. The heating value of waste that consists only of human and animal remains is about 2,325 kJ/Kg (1,000 Btu/lb). As set forth on the testing report attached hereto, testing of products in accordance with the present disclosure resulted in an incineration/heating value of 5692 BTU/lb. well within acceptable limits for complete incineration of human hazardous waste. EPA regulations assume a medical waste incinerators has a standard waste heating value of at least 8,500 Btu/lb. (see, Federal Register, Vol 78, No. 92, pages 28052 et seq., May 13, 2013 and 40 CFR parts 60 and 62, the contents of each of which are incorporated herein by reference in their entireties), thus products in accordance the present disclosure should achieve the required level of incineration.

As the primary ingredient is coir, products in accordance with the present invention are typically safe to use and does not require special handling instructions or precautions prior to use. However, special handling, PPE (Personal Protective Equipment) and disposal recommendations as per local, state and federal regulations should be followed, for the material(s) being cleaned up. Testing of products in accordance with this disclosure has demonstrated that embodiments in accordance with this disclosure meet and exceed federal EPA leachate standards for providing additional protection against landfill contamination.

While this invention has been described in certain embodiments, the present invention can be further modified with the spirit and scope of this disclosure. This application is therefore intended to cover any variations, uses, or adaptations of the invention using its general principles. Further, this application is intended to cover such departures from the present disclosure as come within known or customary practices in the art to which this invention pertains and which fall within the limits of the appended claims.

1. (canceled)

2. A method of disposing of fluid medical waste, comprising:
selecting a product comprising coconut coir;
absorbing liquid medical waste with the selected product to solidify the medical waste; and
disposing of the solidified medical waste.

3. The method of claim 2, wherein selecting a product comprising coconut coir comprises selecting a product comprising loose granulated coconut coir, coconut coir formed into compressed pellets, or a mixture of loose granulated and coconut coir compressed pellets.

4. The method of claim 3, wherein the loose granulated coconut coir has a moisture content of from about 15% to about 20% H₂O and a density of from about 7 lbs/cubic foot to about 12 lbs/cubic foot.

5. The method of claim 3, wherein the compressed pellets have a density of from about 20 lbs/cubic foot to about 35 lbs/cubic foot.

6. The method of claim 3, wherein the compressed pellets have varying diameters from about ⅛ inch to about ½ inch.

7. The method of claim 2, wherein selecting a product comprising coconut coir comprises selecting a product comprising coconut coir and at least one type of microbe for bioremediation of the medical waste.

8. The method of claim 7, wherein selecting a product comprising coconut coir and at least one type of microbe for bioremediation of the medical waste comprises selecting a product comprising bacteria in a dormant state or bacterial spores.

9. The method of claim 7, wherein selecting a product comprising coconut coir and at least one type of microbe for bioremediation of the waste paint comprises selecting a product comprising a blend of one or more different types of microbes.

10. The method of claim 2, wherein absorbing liquid medical waste with the selected product to solidify the medical waste comprises encapsulating the medical waste within the selected product.

11. The method of claim 2, wherein absorbing liquid medical waste with the selected product to solidify the medical waste comprises absorbing a liquid medical waste comprising a human bodily fluid.

12. The method of claim 2, wherein absorbing liquid medical waste with the selected product to solidify the medical waste results in a solidified medical waste, which has a heating value such that it may be completely incinerated in a medical waste incinerator having a standard heating value.

13. The method of claim 12, wherein the solidified medical waste has a heating value of about 5692 BTU/lb.

14. The method of claim 2, wherein disposing of the solidified medical waste product comprises disposing the solidified medical waste into a landfill.

15. The method of claim 2, wherein disposing of the solidified medical waste product comprises incinerating the solidified medical waste.

16. A method of disposing of fluid medical waste, comprising:
encapsulating fluid medical waste in an absorbent product comprising coconut coir to form a combined solid substance, and
disposing of the combined solid substance.

17. The method of claim 16, wherein encapsulating fluid medical waste in an absorbent product comprising coconut coir comprises encapsulating fluid medical waste in an absorbent product comprising coconut coir comprising loose granulated coconut coir, coconut coir formed into compressed pellets, or a mixture of loose granulated and coconut coir compressed pellets.

18. The method of claim 17, wherein the loose granulated coconut coir has a moisture content of from about 15% to about 20% H₂O and a density of from about 7 lbs/cubic foot to about 12 lbs/cubic foot.

19. The method of claim 17, wherein the compressed pellets have a density of from about 20 lbs/cubic foot to about 35 lbs/cubic foot and varying diameters from about ⅛ inch to about ½ inch.

20. The method of claim 16, wherein encapsulating fluid medical waste in an absorbent product comprising coconut coir to form a combined solid substance comprises forming a combined solid substance which has a heating value such that it may be completely incinerated in a medical waste incinerator having a standard heating value.

21. The method of claim 16, wherein disposing of the combined solid substance comprises incinerating the solidified medical waste.
